(19) United States
(12) Patent Application Publication
(10) Pub. No.: US 2014/0301232 A1
(43) Pub. Date: Oct. 9, 2014

(54) APPARATUS AND METHOD FOR CSI CALCULATION AND REPORTING

(71) Applicant: NEC CORPORATION, Minato-ku, Tokyo (JP)

(72) Inventors: Chaitanya Rao, Victoria (AU); Kevin Lin, Victoria (AU); Satha Sathananthan, Victoria (AU); Phong Nguyen, Victoria (AU)

(73) Assignee: NEC CORPORATION, Tokyo (JP)

(21) Appl. No.: 14/354,494

(22) PCT Filed: Sep. 19, 2012
(86) PCT No.: PCT/JP2012/074603

§ 371 Date: Apr. 25, 2014

(30) Foreign Application Priority Data
Oct. 31, 2011 (AU) 2011904521

(51) Int. Cl. H04W 24/10; H04B 7/04; H04L 5/00

(52) U.S. Cl. CPC H04W 24/10; H04L 5/0057; H04B 7/0413
USPC 370/252

(57) ABSTRACT

A method of measuring Channel State Information (CSI) in a multiple input/multiple output (MIMO) communication system including at least one base station (eNodeB) and at least one User Equipment (UE), the method including: receiving a Channel State Information Reference Signal (CSI-RS) carried in a sub-frame of a radio frame of the communication system at the at least one UE from the at least one eNodeB over at least one downlink. channel therebetween; extracting CSI-RS Resource Elements (RE) from the CSI-RS sub-frame; and using the extracted CSI-RS REs to perform downlink channel estimations for active pairs of receiving and transmitting antennas of the UE and the eNodeB respectively to derive the CSI.

### TECHNICAL FIELD

The present invention relates to measuring Channel State Information (CSI) in Multiple Input Multiple Output (MIMO) communication systems, and in particular to improvements in measuring CSI.

### BACKGROUND ART

In existing Multiple Input Multiple Output (MIMO) communication systems, multiple antennas are used at the transmitter and the receiver to improve communication performance and peak data rates therebetween. In Long Term Evolution (LTE) communication systems, for example, multiple antennas can be used at Base Stations (eNodeBs) and User Equipments (UEs) to improve communication performance and peak data rates between the eNodeBs and the UEs. In one example, Channel State Information (CSI) of a communication link between a UE and an eNodeB is estimated at the receiving UE and fed back to the eNodeB for downlink transmission control. In this case, the CSI comprises estimated channel properties such as scattering, fading and power decay with distance, which enable the eNodeB to control downlink transmission based on the current channel conditions.

For example, in an LTE-Advanced communication system, such as an LTE Release 10 system, as illustrated in FIG. 1, there has already been extensive discussion about enhanced channel estimation for Multi User-MIMO (MU-MIMO) as well as for Coordinated MultiPoint (CoMP) communication systems. FIG. 1 shows a simplified diagram of a MIMO communication system showing a single UE 200 and a single eNodeB 300, with the UE 200 and the eNodeB 300 employing multiple antennas for transmitting and receiving data streams. The discussion resulted in specific goals to support Single User MIMO (SU-MIMO) and MU-MIMO, for up to, say, 8 Antenna Ports (APs), and additionally to be as future proof as possible with respect to CoMP. The main outcomes were that:

1. CSI Reference Signals (CSI-RS) have been introduced to the communication system for frequency selective estimation of channel state information (CSI) in a multi cellular environment. The UE 200 shown in FIG. 1 includes a CSI Processing Unit 100 configured to estimate CSI in the multi cellular environment. Also, to limit overhead, CSI reference signals (RS) are to be sparse in frequency (e.g. only one Resource Element (RE) per AP and per physical resource block (PRB) and per time unit (e.g. every 5, 10, 20, 40, 80 ms)). It can be seen that typical CSI RS patterns for 1, 2, 4, 8 APs are illustrated in FIG. 2.

2. CSI-RS orthogonality is to be provided by a combination of Frequency Division Multiplexing (FDM), Code Division Multiplexing (CDM) and Time Division Multiplexing (TDM). One main issue had been the required backward compatibility, e.g. finding resource elements (REs) not yet used for other purposes. FIG. 2 also illustrates the high number of already occupied REs.

3. Muting of REs carrying CSI RSs, also illustrated in FIG. 2, for use in other cells is to be intended for improved orthogonality of CST RSs in multi cellular environments. It will be appreciated by those persons skilled in the art that muting means switching off any transmission of Tx signals at certain REs. In discussion were muting patterns with a reuse of 3 to 5, Besides adding overhead for RSs, LTE Release 8 UEs suffer as they are not aware of this additional puncturing within a PRB requiring slightly higher coding gains. Release 10 UEs, on the other hand, will be informed by signaling about punctured REs making improved decoding possible.

4. CSI RS is to allow for explicit estimation of, for example, 8 channel components for 3 to 5 cooperating cells.

The introduction of a CSI-RS in, for example, LTE Release 10 communication systems enables a CSI calculation to be performed by a UE to be fed back to an eNodeB for downlink transmission control. Thus, there is a need for improved CSI measurement at the UE.

### DISCLOSURE OF THE INVENTION

According to one aspect, the present invention provides a method of measuring Channel State Information (CSI) in a multiple input/multiple output (MIMO) communication system comprising at least one base station (eNodeB) and at least one User Equipment (UE), the method comprising:

receiving a Channel State Information Reference Signal (CSI-RS) carried in a sub-frame of a radio frame of the communication system at said at least one UE from said at least one eNodeB over at least one downlink channel therebetween;

extracting CSI-RS Resource Elements (RE) from the CSI-RS sub-frame; and

using the extracted CSI-RS REs to perform downlink channel estimations for active pairs of receiving and transmitting antennas of the UE and the eNodeB respectively to derive said CSI.

According to another aspect, the present invention provides a User Equipment (UE) arranged to measure Channel State Information (CSI) in a multiple input/multiple output (MIMO) communication system comprising at least one base station (eNodeB) and at least one of said UE, the UE comprising:

a controller configured to:
receive a Channel State Information Reference Signal (CSI-RS) carried in a sub-frame of a radio frame of the communication system at the UE from said at least one eNodeB over at least one downlink channel therebetween; and to
extract CSI-RS Resource Elements (RE) from the CSI-RS sub-frame; and

a CSI measuring unit configured to use the extracted CSI-RS REs to perform downlink channel estimations for active pairs of receiving and transmitting antennas of the UE and the eNodeB respectively to derive said CSI.

### BRIEF DESCRIPTION OF THE DRAWINGS

Embodiments of the present invention will now be described, by way of example only, with reference to the accompanying drawings, in which:

FIG. 1 is a schematic diagram showing a prior art wireless communication system;

FIG. 2 is a graphical depiction of a block of Resource Elements (REs) showing typical CSI Reference Signal (CSI RS) patterns for 1, 2, 4, 8 CSI-RS ports;

FIG. 3 is a schematic diagram of a wireless communication system comprising a User Equipment (UE) arranged to measure channel state information (CSI) according to an embodiment of the present invention;

FIG. 4 is a flowchart showing a method of measuring CSI according to an embodiment of the present invention;

FIG. 5 is a further flowchart showing the method of measuring CSI of FIG. 4;

FIG. 6 is a graphical depiction of an LTE sub-frame carrying a CSI-RS according to an embodiment of the present invention;

FIG. 7 is a graphical depiction of an LTE sub-frame showing a method of estimating noise power for transmit antenna ports 0 and 1 according to an embodiment of the present invention;

FIG. 8 is a graphical depiction of an LTE sub-frame showing a method of estimating noise power for transmit antenna ports 0 and 1 if cell-specific reference signals from the previous sub-frame are unavailable, according to an embodiment of the present invention; and

FIG. 9 is a graphical depiction of an LTE sub-frame showing a method of estimating noise power for transmit antenna ports 2 and 3 according to an embodiment of the present invention.

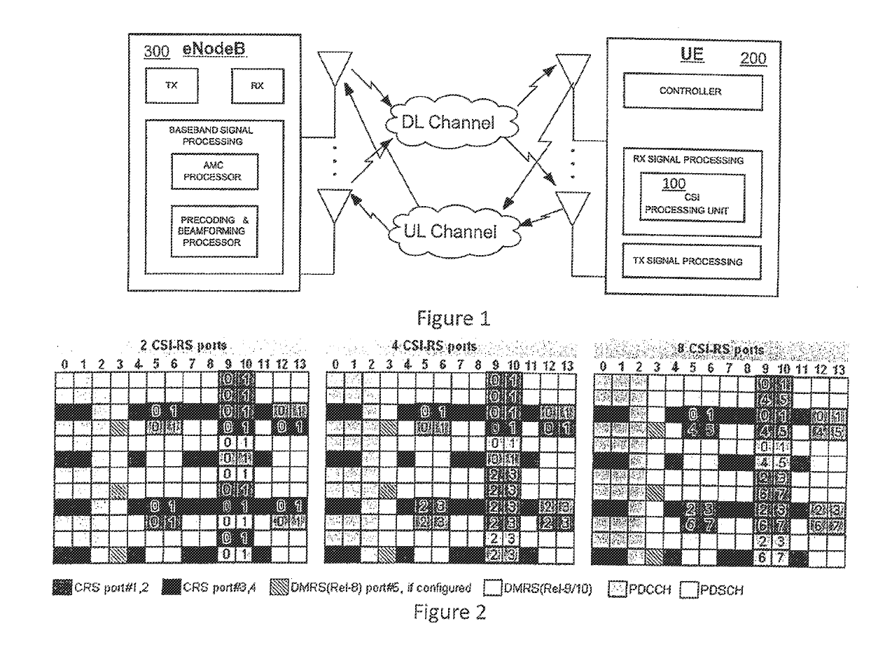

### MODE(S) FOR CARRYING OUT THE INVENTION

According to one aspect, the present invention provides a method of measuring Channel State information (CSI) in a multiple input/multiple output (MIMO) communication system comprising at least one base station (eNodeB) and at least one User Equipment (UE), the method comprising:

receiving a Channel State Information Reference Signal (CSI-RS) carried in a sub-frame of a radio frame of the communication system at said at least one UE from said at least one eNodeB over at least one downlink channel therebetween;

extracting CSI-RS Resource Elements (RE) from the CSI-RS sub-frame; and

using the extracted CSI-RS REs to perform downlink channel estimations for active pairs of receiving and transmitting antennas of the UE and the eNodeB respectively to derive said CSI.

In an embodiment, the introduction of CSI-RS in LTE Release 10 shall require CSI measurement function to be implemented in the UE for the calculation of CSI (e.g. Channel Quality Indicator (CQI), Precoding Matrix Information (PMI), Precoding Type Indicator (PTI) and/or Rank Indicator (RI)) as feedback to be reported to the eNodeB(s) in uplink (UL) channels. Thus, irrespective of the number of transmit TX and receive RX antennas (e.g. TX and RX antenna ports), the embodiment provides the capability to expand for larger numbers of TX and RX antenna ports and for any possible change in the later release LTE UEs to report CSI to achieve higher downlink throughput with minimal complexity.

In an embodiment, the method further comprises receiving a Cell Specific Reference Signal (CRS) carried in a sub-frame of said radio frame at said at least one UE from said at least one eNodeB over said downlink channel;

extracting CRS Resource Elements (RE) from said sub-frame; and

using the extracted CRS REs to perform further downlink channel estimations for said active pairs of said receiving and said transmitting antennas of the UE and the eNodeB respectively to further derive said CSI.

In an embodiment, the CSI-RS is used to produce improved channel estimation for CSI reporting, accounting frequency selective and non-selective nature of the channel across the operating range of Signal to Noise Ratio (SNR).

In an embodiment, the method further comprises using the further downlink channel estimations to perform sub-band noise power estimations for said active pairs of said receiving and said transmitting antennas of the UE and the eNodeB respectively.

In an embodiment, the method further comprises using the sub-band noise power estimations and the downlink channel estimations for said active pairs of said receiving and said transmitting antennas of the UE and the eNodeB respectively to perform sub-band signal power estimations to derive sub-band Signal to Noise (SNR) estimations.

In an embodiment, the method further comprises using the downlink channel estimations to derive a sub-band CSI-RS channel matrix for said active pairs of said receiving and said transmitting antennas of the UE and the eNodeB respectively.

In an embodiment, the method further comprises using the sub-band CSI-RS channel matrix and the sub-band SNR estimations to derive sub-band Signal to Interference Noise Ratio (SINR) estimations.

In an embodiment, the method further comprises using the sub-band Signal to Interference Noise Ratio (SINR) estimations to perform wideband and sub-band Precoding Matrix Information (PMI) calculations for all Rank Indicatorss (RI) and for all Precoding Type Indicators (PTI).

In an embodiment, the method further comprises using the sub-band Signal to Interference Noise Ratio (SINR) estimations to perform wideband and sub-band Channel Quality Indicator (CQI) calculations.

In an embodiment, said CSI comprises said wideband and said sub-band PMI, said wideband and said sub-band CQI, said RI and said PTI.

According to another aspect, the present invention provides a User Equipment (UE) arranged to measure Channel State Information (CSI) in a multiple input/multiple output (MIMO) communication system comprising at least one base station (eNodeB) and at least one of said UE, the UE comprising:

a controller configured to:
receive a Channel State Information Reference Signal (CSI-RS) carried in a sub-frame of a radio frame of the communication system at the UE from said at least one eNodeB over at least one downlink channel therebetween; and to
extract CSI-RS Resource Elements (RE) from the CR-RS sub-frame; and

a CSI measuring unit configured to use the extracted CSI-RS REs to perform downlink channel estimations for active pairs of receiving and transmitting antennas of the UE and the eNodeB respectively to derive said CSI.

In an embodiment, the CSI measuring unit measures and reports CSI to enhance LTE Release 10 and later release LTE UEs performance in terms of its downlink throughput with reduced complexity.

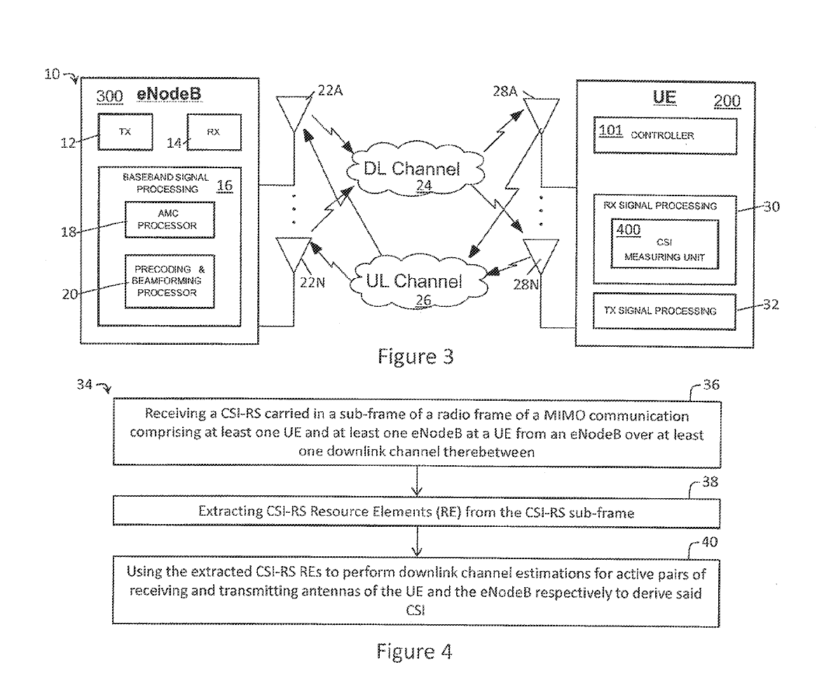

According to an embodiment there is provided a wireless communication system 10, as shown in FIG. 3. The communication system 10 is a multiple input/multiple output (MIMO) communication system comprising a base station (eNodeB) 300 and a User Equipment (UE) 200. The embodiment shown in FIG. 3 is of a Release 10 Long Term Evolution (LTE) communication system which introduces Channel State Information Reference Signals (CSI-RS) for use at the UE 200 as reference to perform Channel State Information (CSI) calculations which are to be fed back to the eNodeB 300 for downlink data communication control. It will be appreciated by those persons skilled in the art that the CST comprises estimated channel properties such as Channel Quality Indicator (CQI), Precoding Matrix Information (PMI), Precoding Type Indicator (PTI) and/or Rank Indicator (RI).

In the embodiment, the UE 200 comprises a number of components to communicate data to/from the eNodeB 300 and to measure Channel State Information (CSI) in the system 10 including a controller 101, a receiver signal processor 30 and a transmitter signal processor 32. Furthermore, the eNodeB 300 comprises a number of components to communicate with the UE 200 over downlink (DL) 24 and uplink (UL) 26 channels including a transmitter controller TX 12 and a receiver controller RX 14 arranged to control eNodeB antennas 22A to 22N. Also, the eNodeB 300 includes a baseband signal processor 16 which includes an AMC processor 18 and a preceding and beamforming processor 20. It can be seen from FIG. 3 that the UE 200 of the MIMO system 10 also has a number of antennas 28A to 28N arranged to operate with respect to the receiver signal processor 30 and the transmitter signal processor 32 to receive and transmit data to/from the UE 300. It can also be seen that the receiver signal processor 30 includes a CSI Measuring unit 400 configured to measure CSI. In use, the controller 101 is configured to receive a Channel State Information Reference Signal (CSI-RS) carried in a sub-frame of a radio frame of the communication system 10 from the eNodeB 300 over at least one downlink channel 24 therebetween and to extract CSI-RS Resource Elements (RE) from the CSI-RS sub-frame. The CSI Measuring unit 400 is configured to use the extracted CSI-RS REs to perform downlink channel estimations for active pairs of the receiving 28A to 28N of the UE 300 and the transmitting 22A to 22N antennas of the eNodeB 300 to derive the CSI.

In addition, the controller 101 is further configured receive a Cell Specific Reference Signal (CRS) carried in a sub-frame of the radio frame from the eNodeB 300 over the downlink channel 24 and extract CRS Resource Elements (RE) from the sub-frame. The CSI Measuring unit 400 is also further configured to use the extracted CRS REs to perform further downlink channel estimations for the active pairs of the receiving antennas 28A to 28N of the UE 300 and the transmitting antennas 22A to 22N of the eNodeB 300 to further derive said CSI.

Also, in an example, certain system installations require the use of more than 4 transmit (TX) antennas at the eNodeB 300 and, in this example, up to 8 TX antennas. To support more than 4 TX antennas, a UE-specific reference signal is also used by the system 10. In any event, in contrast to the cell-specific reference signal (CRS), the UE-specific reference signal is precoded with the same precoding weights as the data transmission and is used by only the UE 200 receiving accompanying traffic data.

As can be seen, FIG. 3 provides a simplified diagram of the wireless communications system 10 employing multiple transmit antennas 22A to 22N for transmitting one or more data streams to the UE 200. In an exemplary embodiment, the eNodeB transceiver 12 and 14 includes radio frequency (RE) transmitter circuitry and RE receiver circuitry, and the baseband signal processor 16 includes baseband signal processing circuitry. The baseband signal processing circuitry includes an adaptive modulation and coding (AMC) processing unit 18 which takes feedback information sent from UE(s) as one of the information to determine the optimum coding and modulation scheme to be applied on a transmitted data streams, and a precoding processing unit 20 which also take feedback information sent from UE(s) as information to determine the optimum number of data streams, precoding matrix and frequency RB for mapping data sent to a particular UE. Signals transmitted from the base station (eNodeB 300) travel through a propagation channel to mobile terminal (User Equipment 200), which include a mobile transceiver and plurality of receive antennas 28A to 28N. The mobile transceiver includes the controller 101 and the transmit signal processing unit 32 and the receiver signal processing unit 30. As described, the receiver signal processing unit 30 includes the CSI measurement unit 400. Those skilled in the art will appreciate that the terms “processing unit” or “processor” as herein described will generally refer to any functional element that may be implemented using one device or several devices, and may be configured with appropriate program code, as necessary, to carry out the feedback calculation including, for example, CQI, PMI, PTI and RI estimation techniques described above.

In principle, the CSI can be measured according to the following analytical method:

The received signal at the RE of time-domain index t and of frequency-domain index i of a pre-coded MEMO system using precoder index P_{R} of sub-codebook associated with rank R:

y_{tiP}_{_{R}}=HₜᵢV_{P}_{_{R}}xₜᵢ+nₜᵢ
y_{tiP}_{_{R}} if the Nᵣₓ×1 received signal vector at the output of the FFT block,
Hₜᵢ the Nᵣₓ×Nₜₓ channel matrix of frequency responses for channel paths of the RE,
Xₜᵢ the R×1 transmitted vector from the output of the layer-mapping block,
nₜᵢ the Nᵣₓ×1 noise vector,
V_{P}_{_{R}} the Nₜₓ×R precoder matrix,

To convert the system into R SISO AWGN channels, a R×Nᵣₓ sized equaliser G_{tiP}_{_{R}} can be used

\hat{x}_{tiP}_{_{R}}=G_{tiP}_{_{R}}y_{tiP}_{_{R}}=G_{tiP}_{_{R}}HₜᵢV_{P}_{_{R}}xₜᵢ+G_{tiP}_{_{R}}nₜᵢ.

For MMSE equaliser,

G_{tiP}_{_{R}}=[ρₜᵢ⁻¹I_{R}+V_{P}_{_{R}}^{H}Hₜᵢ^{H}_i HₜᵢV_{P}_{_{R}}]⁻¹V_{P}_{_{R}}^{H}Hₜᵢ^{H},

where I_{R} is the R×R identity matrix, then

$${SINR}_{ti} ( {P}_{R} , l ) = \frac{{ρ}_{ti}}{{[ {ρ}_{ti}^{- 1} {I}_{R} + {V}_{{P}_{R}}^{H} {H}_{ti}^{H} {H}_{ti} {V}_{{P}_{R}} ]}_{ll}^{- 1}} - 1$$

[ ]ₗₗ⁻¹ denote the (l,l)-th diagonal element of the matrix [ ]⁻¹ which is inverse of the matrix [ ].

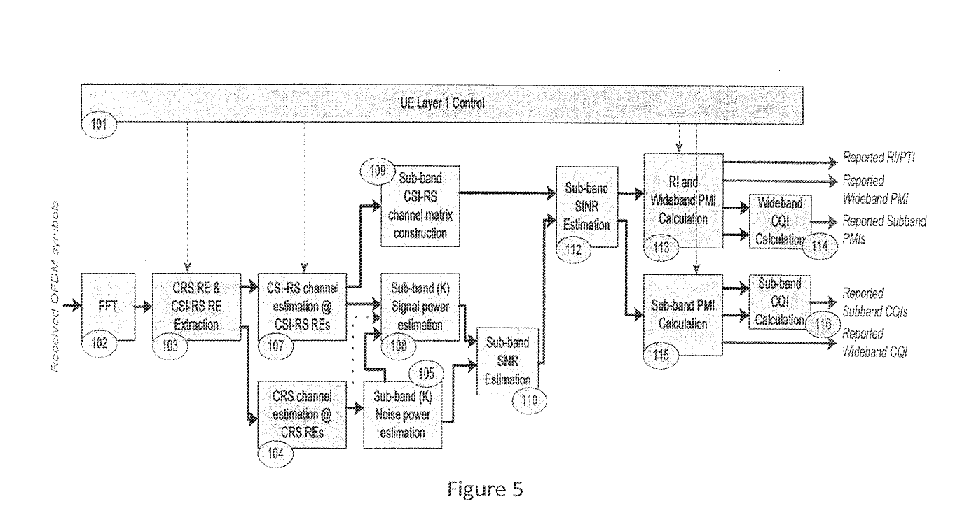

In reference to FIG. 5, the method for CSI measurement shall be implemented according to the following steps

### Step 1:

For a device that is required to perform CSI measurement, via higher layer signaling, the higher layer shall provide Controller-101 CST-RS configuration which include but not limited to the following parameters
Number of CSI-RS ports.
CSI RS sub-frame configuration I_{CSI-RS}.
Subframe configuration period T_{CSI-RS}.
Subframe offset Δ_{CSI-RS}.
UE assumption on reference PDSCH transmitted power for CSI feedback P_{c}. P_{c} is the assumed ratio of PDSCH EPRE to CSI-RS EPRE when UE derives CSI feedback and takes values in the range of [−8, 15] dB with 1 dB step size.
CSI reporting mode.

With the CSI-RS configuration, the controller-101 shall be able to determine which radio frame carries CSI-RS sub-frame and which sub-frame(s) in that a radio frame carries CSI-RS.

### Step 2:

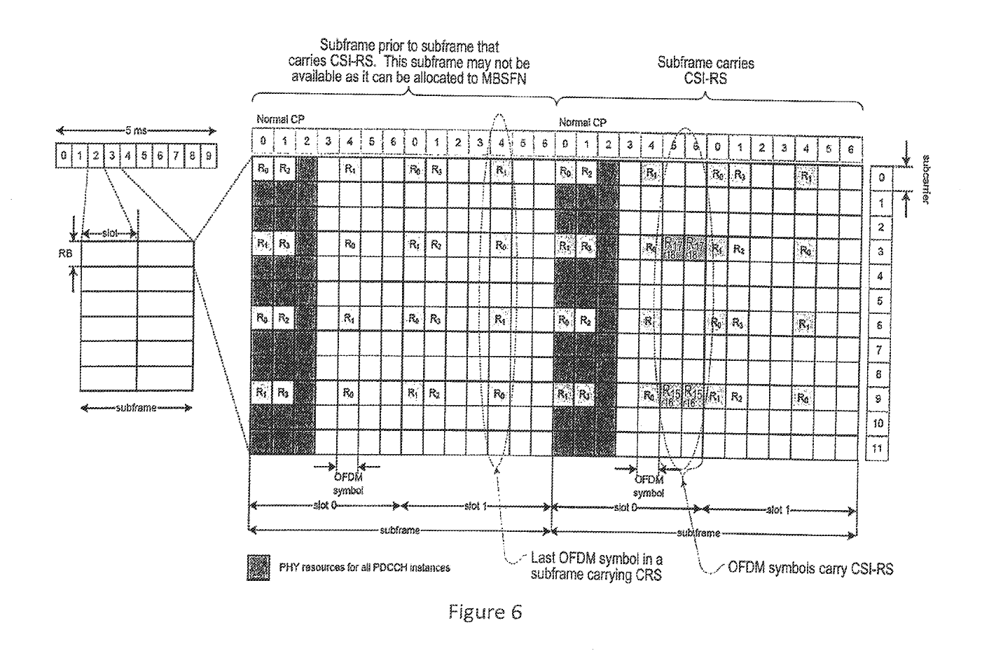

In the radio frame that has CSI-RS sub-frame(s), as shown in FIG. 6, during the sub-frame prior to a CSI-RS sub-frame, the controller-101 shall configure “CRS RE & CSI-RS RE Extraction” unit-103 to perform either of the following:
1.1.1 Extracting CRS REs the last OFDM symbol outputted from FFT unit-102 that carries CRS. If the sub-frame prior to CSI-RS sub-frame is a Non MBSFN (multicast/broadcast single frequency network) sub-frame. And extracting CRS REs and CSI-RS REs in the CSI-RS sub-frame. The last OFDM symbol carries CRS is illustrated in 4.
1.1.2 Ignoring entire sub-frame prior to CSI-RS sub-frame, if the sub-frame prior to CSI-RS sub-frame is a MBSFN sub-frame. And extracting CRS REs and CSI-RS REs in the CSI-RS sub-frame.

### Step 3:

The extracted CRS-REs described in step 2 shall be used as input to ‘CRS channel estimation @CRS REs’ unit-104 for performing LS channel estimation.

### Step 4:

In Step 4, the LS estimations from the unit 104 shall be used for sub-band noise power estimation by “Sub-band (K) Noise power estimation” unit-105.

The “Sub-band (K) Noise power estimation” unit-105 shall determine sub-band noise power (σₑₛₜ_{_{—}}_{sc1}² (a,b,n,K) for each pair of active receive and transmit antennas according to the following:
1. Determine number of Resource Block (RB) in each sub-band: N_{RB}(K)
2. Within a chosen sub-band (K) in 1, and in a space between 2 consecutive OFDM symbols carrying CRS, select the cross-points where noise power shall be calculated,
3. Perform noise power calculation for all determined cross-points in the chosen sub-band,
4. Take average the noise power of a determined cross-points in the chosen sub-band to have sub-band noise σₑₛₜ_{_{—}}_{sc1}² (a,b,n,K) for each pair of active receive (a) and transmit antennas (b)

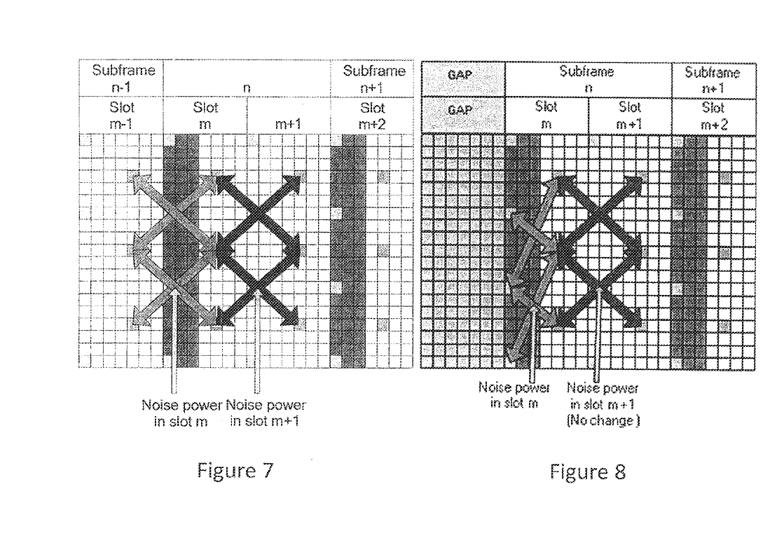

Given 2 transmit antenna on port 0 and 1, with normal CP sub-frame structure, an exemplary implementation of sub-band noise power estimation can be illustrated in FIGS. 7 and 8.

In the case that CRS of sub-frame prior to CSI-RS sub-frame is used in noise power estimation of CSI-RS sub-frame, the CRS of sub-frame prior to CSI-RS sub-frame shall be AGC and timing adjusted to align with the CRS of the CSI-RS sub-frame in magnitude as phase before the noise power calculation can be done.

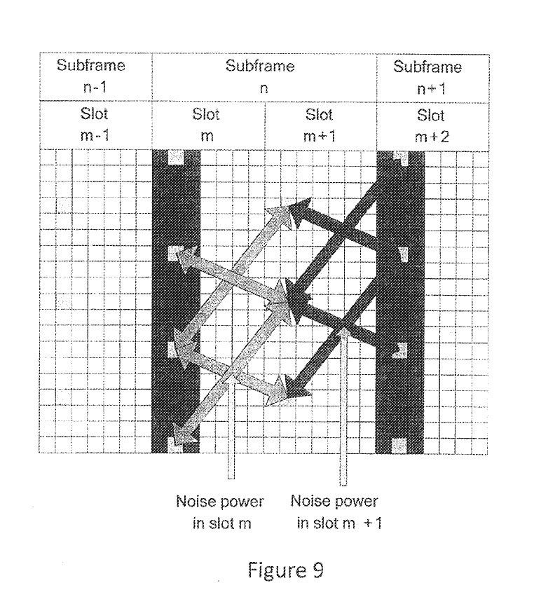

Given 4 transmit antenna on port 0, 1, 2 and 3, with normal CP sub-frame structure, an exemplary implementation of sub-band noise power estimation of the additional 2 antenna port 2 and 3 can be illustrated in FIG. 9.

### Step 5:

Concurrently to CRS channel estimation processing described in step 3 above, the extracted CSI-RS REs resulted in step 2 shall also be used as input to ‘CSI-RS channel estimation @CSI-RS REs’ unit-107 for performing CSI-RS channel estimation.

This CSI-RS channel estimation aims to calculate the following

1. LS channel estimation at the CSI-RS REs position for all active pair RX-TX, and

2. Clean channel estimation at the CSI-RS REs position for all active pair RX-TX.

An exemplary implementation can be done according to the following:

Let Y(a,b,n,r,k) and Y(a,b,n,r,k) be received CSI-RS signal and R(a,b,n,r,k) and R(a,b,n,r,k) are corresponding CSI-RS patterns.

LS estimates H_{CSI} (a,b,n,k) are calculated by applying code division de-multiplexing of the received CSI-RS symbols

Where:
b=15, 16, . . . , 15+N_{TX}−1 denotes CSI-RS ports
a=1, . . . , Nᵣₓ−1 denotes receive antenna
n denotes CSI-RS sub-frame number
k denotes CSI-RS sub-carrier location

Next, stack the LS estimates H_{CSI} into a column vector Z of length N_{RB}^{DL}, then find

ĥ=gₘ×z,

m=0, 1, . . . , N_{RB}^{DL}−1,

where gₘ is the m-th row of the matrix G defined as:

$$G = B \times {[ B + \frac{1}{SNR} I ]}^{- 1} .$$

B is the correlation matrix between the channels at the reference REs; the size of B is N_{RB} by N_{RB}. The (m,n)-th element of B is given by:

$${B}_{m , n} = E \{ {h}_{m} {h}_{n}^{*} \} = {r}_{f} ( m - n )$$

$$Where {r}_{f} ( m - n ) = \frac{1}{1 + {j2πτ}_{rms} \vert m - n \vert Δ f}$$

Here τᵣₘₛ is determined based on frequency slope estimation using CRS.

Wideband SNR (signal-to-noise ratio) is estimated based on CSI-RS LS estimates (H_{CSI}), by calculating CSI-RS wideband noise power σₑₛₜ_{_{—}}_{CSI-RS}² (n) and wideband signal power Sₑₛₜ_{_{—}}_{CSI-RS} (n).

And the wideband CSI-RS SNR is calculated as follows:

$$SNR = {SNR}_{CSI - RS} ( n ) = \frac{{S}_{est\_CSI - RS} ( n )}{{σ}_{est\_CSI - RS}^{2} ( n )}$$

### Step 6:

In step 6, the Sub-band (K) signal power estimation unit 108 shall use
1. the sub-band noise power estimates and resulted from processing unit and 105
2. CSI-RS's LS estimates and 107
To calculate sub-band signal power Sₑₛₜ_{_{—sc1}} (a,b,n,K).

Alternatively, the CRS's LS estimations form the unit 104 can be used for signal power estimation instead of CSI-RS's LS if CRS is used for CSI calculation.

The sub-band signal power estimation using CSI-RS is exemplarily implemented as follows. Signal power estimation is performed by averaging the LS estimate at CSI-RS positions over two neighbouring resource blocks. If there is an odd number of resource blocks in the sub-band, ignore the final resource block.

### Step 7:

In Step 7, with the CST configuration from the controller unit 101, the Sub-band SNR Estimation unit-110 shall take the sub-band signal power estimation and sub-band noise estimation for the last N_{CQI}_{_{—}}_{S} sub-frames to calculate the sub-band SNR(K).

An exemplary implementation of sub-band SNR(K) consists of averaging sub-band noise power estimation and sub-band signal power estimation over the last N_{CQI}_{_{—}}_{S} sub-frames; and

$${S}_{est\_ave} ( a , b , K ) = {r}_{d 2 p} {S}_{est\_sc 1} ( a , b , c , K )$$

$${σ}_{est\_ave}^{2} ( a , b , K ) = ( \frac{1}{{N}_{CQI\_I}} ) {\sum }_{c = n - {N}_{CQI\_I} + 1}^{n} {σ}_{est\_sc 1}^{2} ( a , b , c , K )$$

averaging over all active transmit and receive antennas, then take the ratio to find the received SNR per sub-band.

$$SNR ( K ) = ( \frac{{N}_{tx}}{{N}_{CRS}} ) \times \frac{{\sum }_{b = 0}^{{N}_{CRS} - 1} {\sum }_{a = 0}^{{N}_{rx} - 1} {S}_{est\_ave} ( a , b , K )}{{\sum }_{b = 0}^{{N}_{tx} - 1} {\sum }_{a = 0}^{{N}_{rx} - 1} {σ}_{est\_ave}^{2} ( a , b , K )}$$

### Step 8:

Simultaneously with the sub-band SNR estimation in step 8, the sub-band CSI-RS channel matrix is also established in step 8 as preparation for SINR estimation in the step 9.

The Sub-band CSI-RS channel matrix construction unit-109 shall take clean CSI-RS channel estimates resulted in the processing unit 107 to produce sub-band channel matrix H(f_{K}) at each sampled subcarrier f_{K}.

### Step 9:

As being stated above, the key concept of CSI calculation is to achieve the appropriate SINR (signal-to-interference and noise ratio). In step 9, the sub-band SINR estimation unit-112 shall calculate ‘sub-band SINR’ by taking Sub-band CSI-RS channel matrix and Sub-band SNR estimation from processing unit 109 and 110 as inputs. An exemplary implementation of SINR(P_{R},l,f_{K},K) for all RI (rank indicator) R=1, 2, for all PMI (precoding matrix indicator) associated with a RI P_{R}∈Ω_{R}, and for all layers l=1, . . . , R is represented according to:

$$SINR ( {P}_{R} , l , {f}_{K} , K ) = \frac{SNR ( K )}{{[ {SNR ( K )}^{- 1} {I}_{R} + {V}_{{P}_{R}}^{H} {H ( {f}_{K} )}^{H} H ( {f}_{K} ) {V}_{{P}_{R}} ]}_{ll}^{- 1}} - 1$$

$${f}_{K} ∈ {F}_{K} := \{ 12 ( {KN}_{RB} + i ) + {i}_{0} , i = 0 , 1 , … , {N}_{RB} ( K ) - 1 , {N}_{RB} = {max}_{K} {N}_{RB} ( K ) \} .$$

Here:
I_{R} is the R×R identity matrix;
[ ]ₗₗ⁻¹ denote the (l,l)-th diagonal element of the matrix [ ]⁻¹ which is inverse of matrix [ ].
V_{P}_{_{R}}=W is the P-th precoder in the sub-codebook with rank R.

### Step 10:

With the knowledge of UL PhCH transmission availability and also the reporting mode applicability, the controller 101 shall configure either RI Wideband PMI calculation unit-113 or Sub-band PMI calculation unit-115 to perform wideband PMI or sub-band PMI calculation.

In step 10, with sub-band SINR as input, The RI and Wideband PMI processing unit-113 shall select RI \hat{R} and wideband PMI \hat{P}_{w} (the latter for PUSCH modes 3-1 and 2-2 ) such that the preferred precoder in its associated codebook to provide the highest maximum capacity sum according to:

$$\begin{matrix}\hat{R} , {\hat{P}}_{w} = {argmax}_{R ∈ \{ 1 , 2 \}} {max}_{{P}_{R} ∈ {Ω}_{R}} {\sum }_{K = 0}^{{N}_{S} - 1} {\sum }_{{f}_{K} ∈ {F}_{K}} {\sum }_{l = 1}^{R} {log}_{2} ( 1 + SINR ( {P}_{R} , l , {f}_{K} , K ) ) \\ = {argmax}_{R ∈ \{ 1 , 2 \}} {max}_{{P}_{R} ∈ {Ω}_{R}} {\prod }_{K = 0}^{{N}_{S} - 1} {\prod }_{{f}_{K} ∈ {F}_{K}} {\prod }_{l = 1}^{R} ( 1 + SINR ( {P}_{R} , l , {f}_{K} , K ) )\end{matrix}$$

Here N_{S} denotes the total number of sub-bands.

In step 10, with sub-band SINR as input, The Sub-band PMI processing unit-115 shall select sub-band PMI \hat{P}_{S}(K) (PUSCH mode 1-2 ), to provide the maximum capacity sum according to:

$$\begin{matrix}{\hat{P}}_{S} ( K ) = {argmax}_{{P}_{R} ∈ {Ω}_{\hat{R}}} {\sum }_{{f}_{K} ∈ {F}_{K}} {\sum }_{l = 1}^{\hat{R}} {log}_{2} ( 1 + SINR ( {P}_{\hat{R}} , l , {f}_{K} , K ) ) \\ = {argmax}_{{P}_{R} ∈ {Ω}_{R}} {\prod }_{{f}_{K} ∈ {F}_{K}} {\prod }_{l = 1}^{\hat{R}} ( 1 + SINR ( {P}_{\hat{R}} , l , {f}_{K} , K ) )\end{matrix}$$

Calculations for PUCCH modes are similar, with the PMI calculated based on the last reported RI.

### Step 11: CQI (Channel Quality Indicator)

With the knowledge of UL physical channel availability for transmission and also the reporting mode applicability, the controller 101 shall configure either Wideband CQI calculation unit-114 or Sub-band CQI calculation unit-116 to perform wideband CQI or sub-band CQI calculation.

In step 11, with the calculated wideband PMI as input, the wideband CQI calculation unit-114 shall calculate C_{wPMI-wCQI} (l), l=1, . . . , \hat{R} according to:

$${C}_{wPMI - wCQI} ( l ) = \frac{1}{{\sum }_{K = 0}^{{N}_{S} - 1} ⌈ \frac{2 {N}_{RB} ( K )}{{N}_{{f}_{K}}} ⌉} {\sum }_{K = 0}^{{N}_{S} - 1} {\sum }_{{f}_{K} ∈ {F}_{K}} {log}_{2} ( 1 + SINR ( {\hat{P}}_{w} , l , {f}_{K} , K ) ) .$$

Then calculate SINR_{wPMI-wCQI} (l), l=1, . . . , \hat{R} according to:

SINR_{wPMI-wCQI}(l)=2_{C}^{_{wPMI−wCQI}}^{(l)}−1.

Also In step 11, with the calculated sub-band PMI as input, when being configured, the sub-band CQI calculation unit-116 shall calculate C_{sPMI-wCQI} (l), l=1, . . . , \hat{R} according to:

$${C}_{wPMI - wCQI} ( l ) = \frac{1}{{\sum }_{K = 0}^{{N}_{S} - 1} ⌈ \frac{2 {N}_{RB} ( K )}{{N}_{{f}_{K}}} ⌉} {\sum }_{K = 0}^{{N}_{S} - 1} {\sum }_{{f}_{K} ∈ {F}_{K}} {log}_{2} ( 1 + SINR ( {\hat{P}}_{S} , ( K ) , l , {f}_{K} , K ) )$$

Then calculate SINR_{sPMI-wCQI} (l), l=1, . . . , \hat{R} according to:

SINR_{sPMI-wCQI}(l)=2^{C}^{_{sPMI−wCQI}}^{(l)}=1.

Finally, the SINR is then mapped to a CQI index by converting it to a dB scale, then quantising it based on a set of SINR thresholds. These thresholds are found by a tuning process whereby each threshold corresponds to a 10% block error rate for the modulation scheme and coding rate that is applied for each CQI index.

Referring back to FIG. 4, there is shown a summary of a method 34 of measuring Channel State Information (CSI) in a multiple input/multiple output (MIMO) communication system comprising at least one base station (eNodeB) and at least one User Equipment (UE). The method comprising receiving 36 a Channel State Information Reference Signal (CSI-RS) carried in a sub-frame of a radio frame of the communication system at a UE from a eNodeB over at least one downlink channel therebetween, extracting 38 CSI-RS Resource Elements (RE) from the CSI-RS sub-frame, and using 40 the extracted CSI-RS REs to perform no downlink channel estimations for active pairs of receiving and transmitting antennas of the UE and the eNodeB respectively to derive said CSI.

It is to be understood that various alterations, additions and/or modifications may be made to the parts previously described without departing from the ambit of the present invention, and that, in the light of the above teachings, the present invention may be implemented in software, firmware and/or hardware in a variety of manners as would be understood by the skilled person.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

Throughout the description and claims of this specification, the word “comprise” and variations of the word, such as “comprising” and “comprises”, is not intended to exclude other additives, components, integers or steps.

This application is based upon and claims the benefit of priority from Australian provisional patent application No. 2011904521, filed on Oct. 31, 2011, the disclosure of which is incorporated herein in its entirety by reference.

1. A method of measuring Channel State Information (CSI) in a multiple input/multiple output (MIMO) communication system comprising at least one base station (eNodeB) and at least one User Equipment (UE), comprising:
receiving a Channel State Information Reference Signal (CSI-RS) carried in a sub-frame of a radio frame of the communication system at said at least one UE from said at least one eNodeB over at least one downlink channel therebetween;
extracting CSI-RS Resource Elements (RE) from the CSI-RS sub-frame; and
using the extracted CSI-RS REs to perform downlink channel estimations for active pairs of receiving and transmitting antennas of the UE and the eNodeB respectively to derive said CSI.

2. A method as claimed in claim 1, further comprising:
receiving a Cell Specific Reference Signal (CRS) carried in a sub-frame of said radio frame at said at least one UE from said at least one eNodeB over said downlink channel; extracting CRS Resource Elements (RE) from said sub-frame; and
using the extracted CRS REs to perform further downlink channel estimations for said active pairs of said receiving and said transmitting antennas of the UE and the eNodeB respectively to further derive said CSI.

3. A method as claimed in claim 2, further comprising:
using the further downlink channel estimations to perform sub-band noise power estimations for said active pairs of said receiving and said transmitting antennas of the UE and the eNodeB respectively.

4. A method as claimed in claim 3, further comprising:
using the sub-band noise power estimations and the downlink channel estimations for said active pairs of said receiving and said transmitting antennas of the UE and the eNodeB respectively to perform sub-band signal power estimations to derive sub-band Signal to Noise (SNR) estimations.

5. A method as claimed in claim 4, further comprising:
using the downlink channel estimations to derive a sub-band CSI-RS channel matrix for said active pairs of said receiving and said transmitting antennas of the UE and the eNodeB respectively.

6. A method as claimed in claim 5, further comprising:
using the sub-band CSI-RS channel matrix and the sub-band SNR estimations to derive sub-band Signal to Interference Noise Ratio (SINR) estimations.

7. A method as claimed in claim 6, further comprising:
using the sub-band Signal to Interference Noise Ratio (SINR) estimations to perform wideband and sub-band Precoding Matrix Information (PMI) calculations for all Rank Indicatorss (RI) and for all Precoding Type Indicators (PTI).

8. A method as claimed in claim 7, further comprising:
using the sub-band Signal to Interference Noise Ratio (SINR) estimations to perform wideband and sub-band Channel Quality Indicator (CQI) calculations.

9. A method as claimed in claim 8, wherein said CSI comprises said wideband and said sub-band PMI, said wideband and said sub-band CQI, said RI and said PTI.

10. A User Equipment (UE) arranged to measure Channel State Information (CSI) in a multiple input/multiple output (MIMO) communication system comprising at least one base station (eNodeB) and at least one of said UE, comprising:
a controller configured to:
receive a Channel State Information Reference Signal (CSI-RS) carried in a sub-frame of a radio frame of the communication system at the UE from said at least one eNodeB over at least one downlink channel therebetween; and to
extract CSI-RS Resource Elements (RE) from the CSI-RS sub-frame; and
a CSI measuring unit configured to use the extracted CSI-RS REs to perform downlink channel estimations for active pairs of receiving and transmitting antennas of the UE and the eNodeB respectively to derive said CSI.
